(19) United States
(12) Patent Application Publication
(10) Pub. No.: US 2019/0272490 A1
(43) Pub. Date: Sep. 5, 2019

(54) SYSTEM AND METHOD FOR PRIORITIZATION OF OPTIONS ACROSS A GROUP

(71) Applicant: ForgeWeld Apps, LLC, Deep Gap, NC (US)

(72) Inventor: Michael Benjamin Stewart, Deep Gap, NC (US)

(73) Assignee: ForgeWeld Apps, LLC, Deep Gap, NC (US)

(21) Appl. No.: 15/911,214

(22) Filed: Mar. 5, 2018

(51) Int. Cl. G06Q 10/06; G06F 16/22

(52) U.S. Cl. CPC G06Q 10/06313; G06F 16/2282

(57) ABSTRACT

A paired comparison system for a group of members comprising a matrix generator to generate a plurality of matrices corresponding to respective ones of the members in the group, the matrix generator configured to store the plurality of options within each of the plurality of matrices in a random order. A comparison module operable to present paired comparisons to respective ones of the members, wherein for empty cells of each of the plurality of matrices, the option stored in the associated row is compared with the option in the associated column and the member associated with the matrix selects one of the paired options. A group prioritization module to generate a single prioritized list of the plurality of options based on the number of times each one of the options was selected when presented in a paired comparison.

### SUMMARY

According to one aspect, a paired comparison system for a group of members, the system comprising a matrix generator to generate a plurality of matrices corresponding to respective ones of the members in the group, the matrix generator configured to receive a plurality of options and store the plurality of options within each of the plurality of matrices in a random order, each of the plurality of matrices having a first row of cells and a first column of cells, the randomized orders of the plurality of options being stored within the first row of cells and the first column of cells in each of the plurality of matrices; a comparison module operable to present paired comparisons to respective ones of the members, wherein for empty cells of each of the plurality of matrices, the option stored in the associated row is compared with the option in the associated column and the member associated with the matrix selects one of the paired options; and a group prioritization module to sum a number of times respective ones of the options were selected by the members in the group as one of the paired options and, in response, generate a single prioritized list of the plurality of options based on the number of times each one of the options was selected when presented in a paired comparison.

According to another aspect, a non-transitory computer readable medium storing instructions that when executed by a processor cause the processor to perform a method for paired comparison for a group of members comprising generating a plurality of matrices corresponding to respective ones of the members in the group, wherein a plurality of options stored within each of the plurality of matrices, each of the plurality of matrices having a first row of cells and a first column of cells, the plurality of options being stored within the first row of cells and the first column of cells in each of the plurality of matrices; randomly presenting paired comparisons to respective ones of the members, wherein for selected empty cells of each of the plurality of matrices, the option stored in the associated row is compared with the option in the associated column and the member associated with the matrix selects one of the paired options; and summing a number of times respective ones of the options are selected by the members in the group from the paired options and, in response, generating a single prioritized list of the plurality of options based on the number of times each one of the options was selected when presented in a paired comparison.

### BRIEF DESCRIPTION OF THE DRAWINGS

Reference will now be made to the attached drawings, when read in combination with the following specification, wherein like reference numerals refer to like parts throughout the several views, and in which:

FIG. 1 is a schematic illustration of a paired comparison system for prioritizing options for a group of member users, according to one embodiment.

FIGS. 2A-2C are illustrations of cells arranged in tables in respective ones of a plurality of matrices, as well as illustrations of associated user output listings, according to some illustrated embodiments.

FIG. 2D is a table illustration of a result of combining a plurality of user outputs associated with respective ones of the matrices, according to one embodiment.

FIGS. 3-6 are various screenshot illustrations of an application stored on respective devices of the members and leveraged by the members to interact with the paired comparison system, according to one embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Paired Comparison Analysis or Comparative Analysis is used to help individuals work out the importance of a number of options relative to one another. This makes it easy to choose the most important problem to solve, or to pick the solution that will be most effective. It also helps a person set priorities where there are conflicting demands on that person's resources. Leveraging Paired Comparison is particularly useful when objective data that may help make a decision, is lacking. Paired Comparison allows for the comparison of options. One example is deciding between several candidate options to fill an employer's open position.

Current Paired Comparison tools automate the technique. In particular, current automated Paired Comparison tools create a matrix table of cells. A top row of cells in the matrix has respective options stored therein, and a left-most column of cells in the matrix also has those same options respectively stored therein. For each of the empty cells in the matrix, the tool compares the option in that row with the option in that column. A user reviews the comparison and decides on one of the two options (the paired comparison). Of course, the tool blocks out cells where the comparison would be between the option and itself, as well as cells where there would be a duplicative comparison.

According to some implementations of the tool, for each comparison, the user merely selects the more important option while in other implementations the user additionally scores the difference in importance between the paired options. The scored difference may be a number score (e.g., 0-10 scale). Finally, the conventional tool consol-idates the results by adding the total values stored in the row of cells associated with each option. Based on the total scores for each option, the tool outputs a prioritized listing of the options for the user.

In essence, conventional software-based tools currently available, create the row/column cell matrix to determine the prioritized listing of options for each user. In other words, for each user, the tool creates a prioritized listing of options. When a group of users require a group decision on prioritizing options or tasks, current tools generate a separate cell matrix for each user and then each user has his/her own prioritized option list. Then, a manual analysis or a separate tool must be leveraged to aggregate the prioritized options for each one of the users to create a single prioritized listing of options or tasks for the group to act upon. The manual analysis of each prioritized listing of tasks will prevent anonymity of users' choices and be time consuming.

Additionally, current automated paired analysis tools implement an ordered comparison of row/column options for each cell. In such scenario, the option being compared first to all the other options, might be deemed by the users as the preferred option by the creator of the tool or proposer of the options. As such, there might be in-herent bias to choose the first option or purposefully not choose that option. For example, if somebody asks you whether you'd rather go to:
(1) dinner over movies, basketball, pub; and then asks
(2) movies over dinner, basketball, pub; and then asks
(3) basketball over dinner, movies, pub; the user might feel a bias toward selecting dinner.

As such, it is desirable to have a paired analysis system that automates the prioritized listing of options for an entire group, rather than only an individual. Additionally, a randomized presentation of options would be desirable to prevent bias of one option over others.

Various examples of embodiments of the invention will now be described. The following description provides specific details for a thorough understanding and enabling description of these examples. One skilled in the relevant art will understand, however, that embodiments of the invention may be practiced without many of these details. Likewise, one skilled in the relevant art will also understand that embodiments incorpo-rate many other obvious features not described in detail herein. Additionally, some well-known structures or functions may not be shown or described in detail below, so as to avoid unnecessarily obscuring the relevant description.

The terminology used herein is to be interpreted in its broadest reasonable manner, even though it is being used in conjunction with a detailed description of certain specific examples of the invention. Indeed, certain terms may even be emphasized below; any terminology intended to be interpreted in any restricted manner will, however, be overtly and specifically defined as such in this Detailed Description section.

The figures along with the following discussion provide a brief, general description of a suitable environment in which embodiments of the invention can be implemented. Although not required, aspects of various embodiments are described below in the general context of computer-executable instructions, such as routines executed by a general purpose data processing module, e.g., a networked server computer, cloud server, mobile device, tablet, or personal computer. Those skilled in the relevant art will appreciate that embodiments can be practiced with other communications, data processing, or computer system configurations, including: Internet appliances, hand-held devices (including smart phones, tablets, and personal digital assistants (PDAs)), wear-able computers, all manner of corded, landline, fixed line, cordless, cellular or mobile phones, smart phones, multi-processor systems, microprocessor-based or programmable consumer electronics, set-top boxes, network PCs, mini-computers, mainframe computers, media players and the like. Indeed, the terms “computer,” “server,” and the like are generally used interchangeably herein, and refer to any of the above devices and systems, as well as any data processor.

While embodiments of the invention, such as certain functions, may be described as being performed on a single device, embodiments of the invention can also be practiced in distributed environments where functions or modules are shared among disparate processing devices, which are linked through a communications network, such as, for example, a Local Area Network (LAN), Wide Area Network (WAN), the Internet, Bluetooth, and Zigbee. In a distributed computing environment, program modules may be located in both local and remote memory storage devices.

Embodiments of the invention may be stored or distributed on tangible comput-er-readable media, including magnetically or optically readable computer discs, cloud servers, hard-wired or preprogrammed chips (e.g., EEPROM semiconductor chips), nanotechnology memory, biological memory, or other data storage media. Alternatively or additionally, computer implemented instructions, data structures, screen displays, and other data under aspects of embodiments of the invention may be distributed over the Internet and via cloud computing networks or on any analog or digital network (packet switched, circuit switched, or other scheme).

The computer readable medium stores computer data, which data may include computer program code that is executable by a computer, in machine readable form. By way of example, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as comput-er-readable instructions, data structures, program modules or other data. Computer readable storage media includes, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

Embodiments of the invention are described herein with reference to operational illustration of modules and flowcharts having functional blocks to illustrate methods employed by modules to estimate the top pure breeds that make up a mixed breed canine. It will be understood that each of the modules, blocks, and combinations thereof may be implemented by analog or digital hardware and computer program instructions. The computer program instructions may be provided to a processor of a general purpose computer, special purpose computer, application-specific integrated circuit (ASIC), or other programmable data processing apparatus such that the instructions, which exe-cute via the processor of the computer or other programmable data processing apparatus, implements the functions/acts specified in the functional blocks of the flowcharts and/or the operational modules.

In some embodiments, the methods illustrated by the functional blocks may occur out of the order noted in the operational illustration of the modules. For example, two blocks shown in succession may be executed substantially concurrently. Alternatively and/or additionally, the blocks may be executed in reverse order.

A module is a software, hardware, or firmware (or combination thereof) system, process or functionality, or component thereof, that performs or facilitates the processes, features, and/or functions described herein. A module may include sub-modules. Software components of a module may be stored on a computer readable medium. Modules may be integral to one or more servers, or be loaded and executed by one or more servers. One or more modules may be grouped into an application.

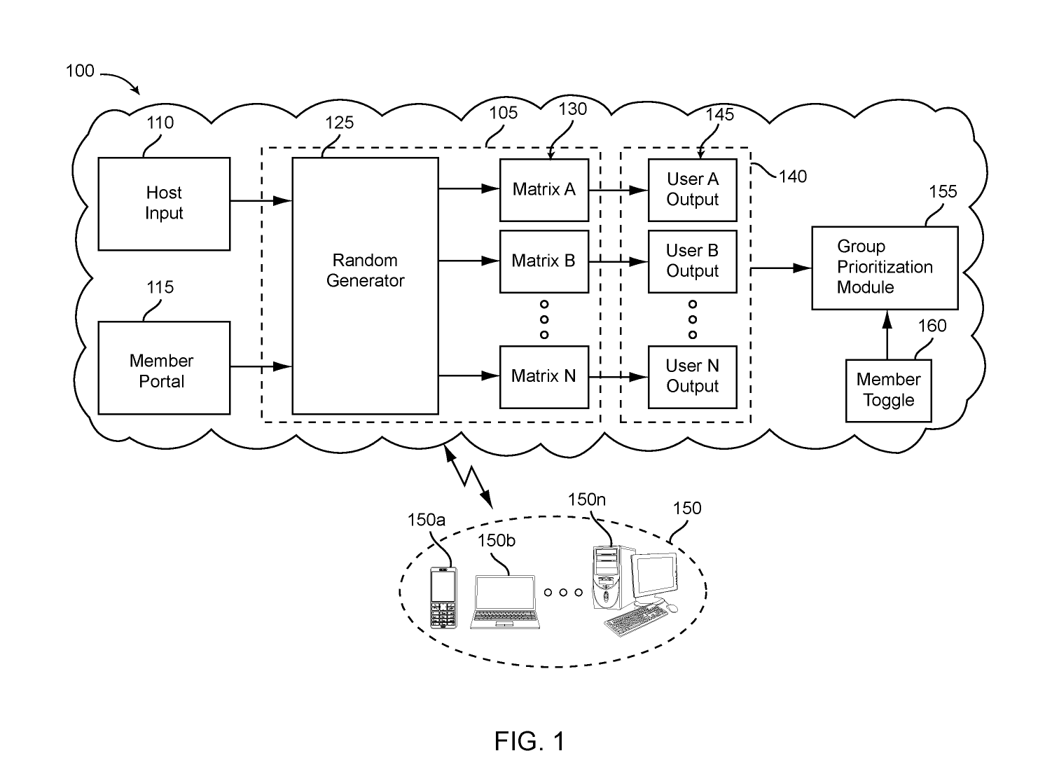

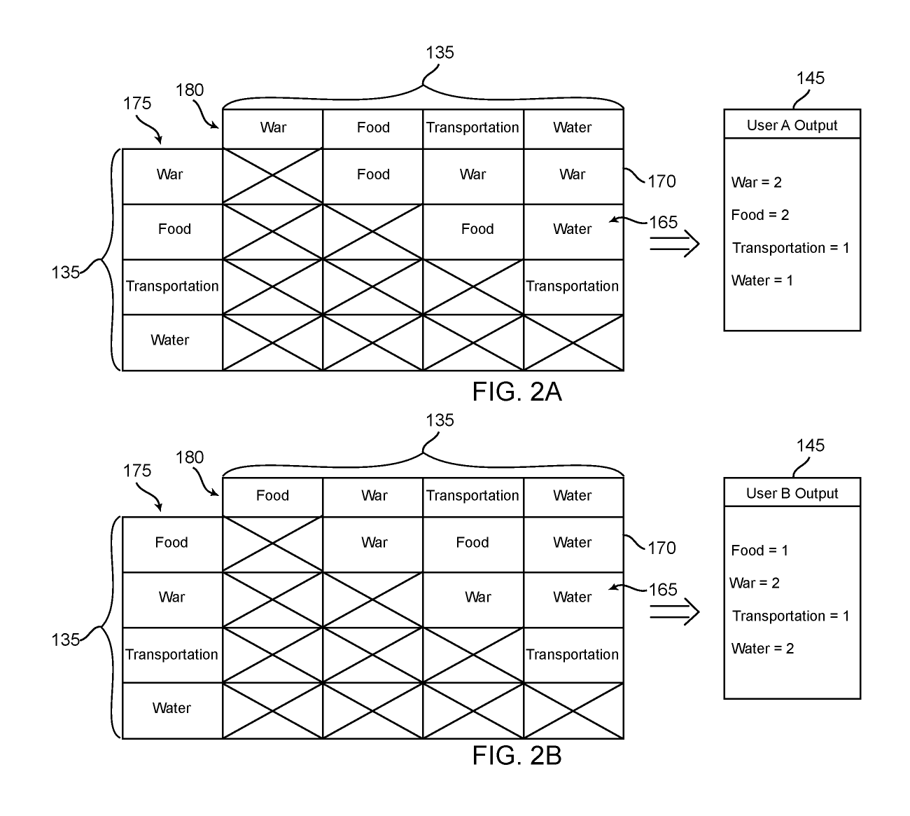

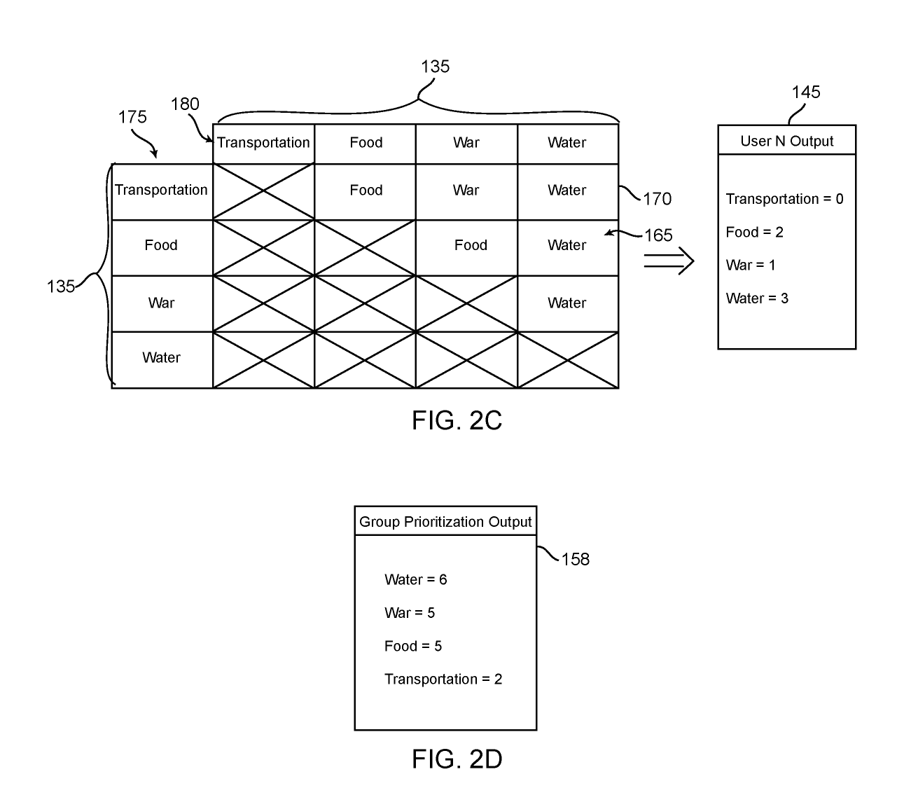

FIG. 1 shows a schematic illustration of a paired comparison system 100 for prioritizing options for a group of users, according to one embodiment. The comparison system 100 comprises a matrix generator 105 communicatively coupled to a host input module 110 and a member portal 115. The matrix generator 105 includes a random generator 125 that is leveraged to create a plurality of matrices 130 (Matrix A, Matrix B, . . . Matrix N are collectively referenced herein as 130). The matrices 130 are associated with the number of members that log into the member portal 115. Additionally, the random generator 125 receives a plurality of options 135 (illustrated in FIGS. 2A-2C) from the host input module 110. The plurality of options 135 may, for example, be tasks, pro-jects, problems, or the like. The random generator 125 may, for example, be configured to randomize the plurality of options 135 received from the host input module 110 and then store the randomly organized options in the plurality of matrices 130. Each of the matrices 130 includes a different randomization scheme of the plurality of options 130 as the random generator 125 generates different randomization schemes for each matrix 130. In another embodiment, the plurality of options 135 received from the host input module 110 are stored in the same order within the plurality of matrices 130. However, in such embodiment, the random generator 125 may present paired comparisons between respective ones of the plurality of options 135 in a random order (as will be discussed in more detail below).

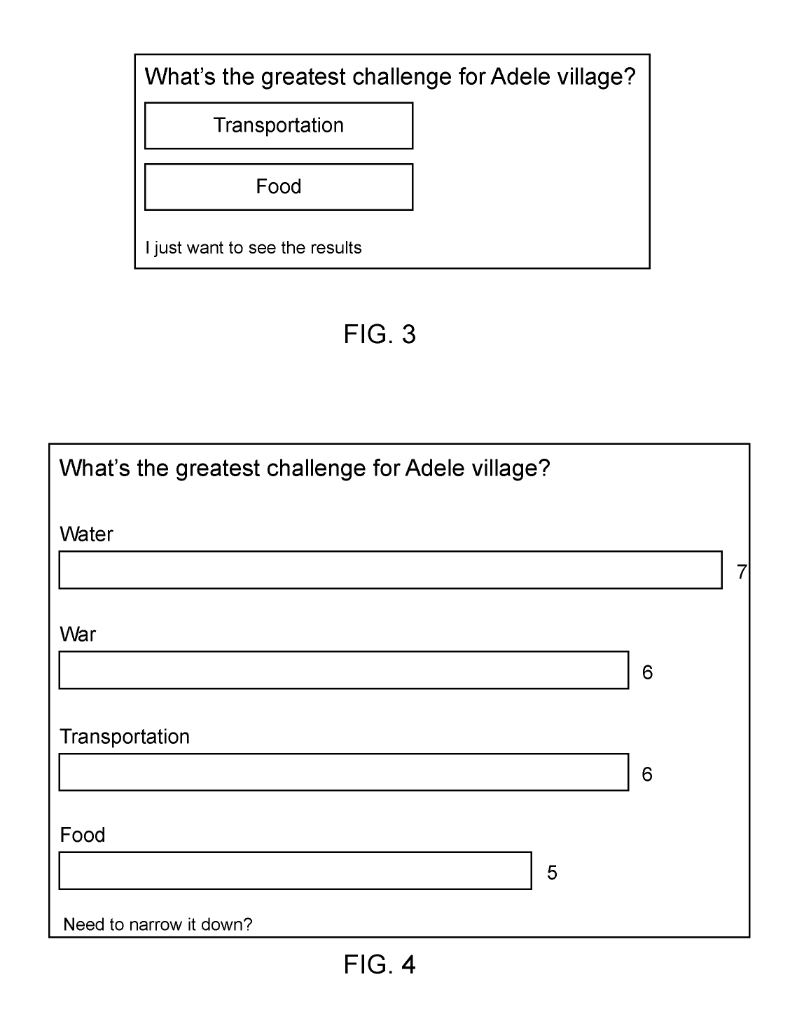

Additionally, a comparison module 140 may be configured to implement a paired comparison or comparative analysis technique on each of the plurality of matrices 130 having the randomized options stored therein. The comparison module 140 presents various pairwise comparisons between the plurality of options 130 to respective users or members 150 of the system 100. In response, for each of the presented pairwise comparisons presented, the user 150 selects one of the paired options (See e.g., FIG. 3 screenshot illustration of a pairwise comparison presented to the member). This is re-peated for all possible paired comparisons between the options 135 for respective matrices 130. As a result, the comparison module 140 provides a plurality of user outputs 145 (user A output, user B output, . . . , user N output are collectively referenced herein as 145) corresponding to each of the plurality of matrices 130. For example, FIG. 2A illustrates Matrix A with the associated plurality of outputs illustrated as “User A Output.” Similar illustrations for other matrices and corresponding user outputs are illustrated in FIGS. 2B-2C. The user outputs 145 are a listing of prioritized options corresponding to respective ones of the plurality of matrices 130. Each of the user outputs 145 is deter-mined based on a number of times the respective user or member 150 selected one of the options over the other in response to a pairwise comparison. In FIG. 1, computing devices 150a, 150b, . . . 150n are devices running an application providing users access to the system 100. Although 150a, 150b, . . . 150n are computing devices (e.g., smartphone, tablet, laptop, or the like) providing access to the system 100, members of the system may use these devices. A such, reference is made to 150 when referencing the members or users.

A group prioritization module 155 is configured to aggregate the plurality of user outputs 145 calculated by the comparison module 140 and determine a single prioritized listing 158 of all the plurality of options 135 across all the members 150. As will be described in more detail below, the prioritization module 155 sums the number of times each of the plurality of options 135 have been selected by the members 150. Based on such summation, the options 135 are prioritized by the prioritization module 155. The prioritization module 155 is communicatively coupled to the plurality of members 150, such that the prioritized listing 158 of the options 135 is accessible to the members 150.

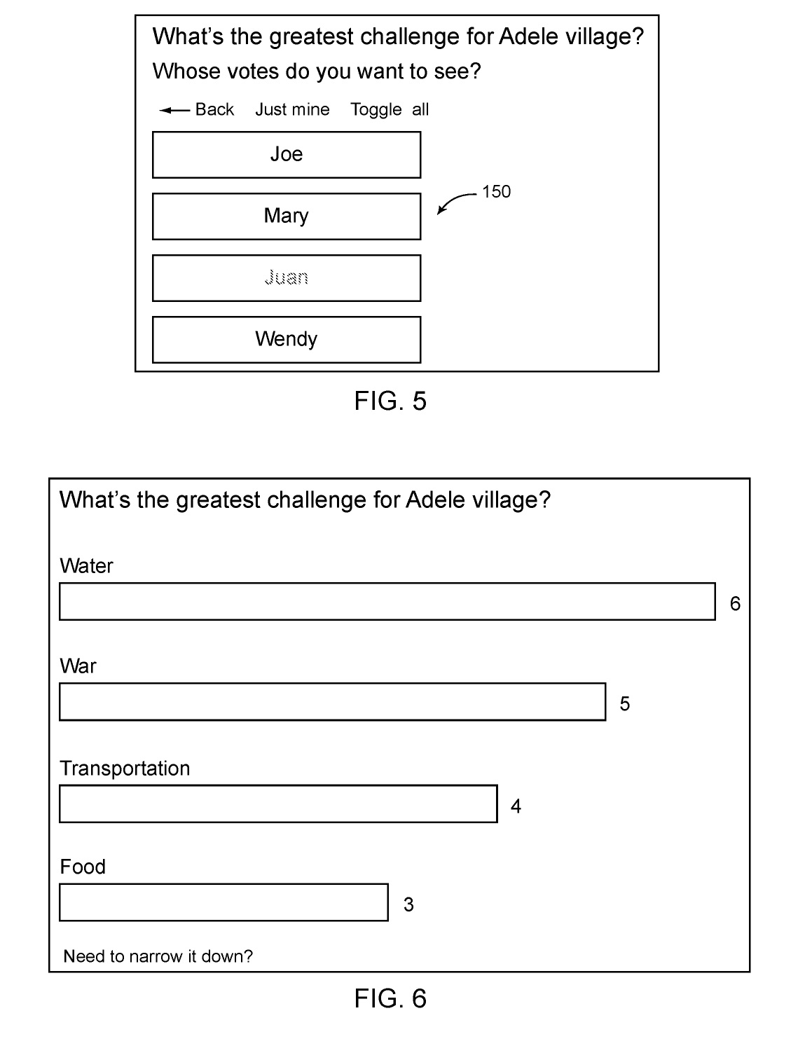

Furthermore, a member toggle 160 may be employed by the system 100 to allow for each member who views the group prioritization of options 158, to filter out the user output 145 results of one or more users, as will be described in more detail below with regard to FIGS. 5-6. Each of the members 150 may have access to the comparison system 100 via a mobile application stored in a computing device. The computing device may take the form of a mobile device, such as for example, a mobile phone, smartphone, tablet, laptop, or the like which provides a user interface for the members 150 to interact with the comparison system 100. More details and illustrations of the user interface are provided herein with reference to FIGS. 3-6.

The host input module 110 allows for a host, for example, a project manager or meeting leader to pose a question to the group of members 150. Along with the question, the host offers the plurality of options 135. For example, the host might pose: “What's the greatest challenge for Adele village?” (where Adele is a village in Ethiopia). The plurality of options 135 associated with the question or problem may, for example, be water, food, transportation, and war (See FIGS. 2A-2C). In other words, the host may unpack a complex decision into several discrete choices for the group of members 150. For example, the host may log into the application to access the comparison system 100. Upon entering the host login credentials, the question may be uploaded into the system 100 along with the plurality of choices 135 the host creates.

Similar to the host input module 110, the member portal 115 allows the group of members 150 to login and access the comparison system 100. Member status allows users access to the system 100 and the ability to make selections between paired options. In particular, the system 100 records the login information provided by a first one of the members 150 and associates this with one of the matrices 130. As mentioned above, each of the matrices 130 in the matrix generator 105 may include a different random disbursement of the plurality of options 135 created by the host during login.

FIGS. 2A-2C show illustrations of cells arranged in tables in respective ones of the plurality of matrices 130, as well as associated user output listings 145, according to illustrated embodiments. Reference will now be made to FIGS. 2A-2C.

As mentioned above, the matrix generator 105 receives the plurality of options 135 from the host input module 110. In one embodiment, the random generator 125 may create different ordered sets of options, which are stored in respective ones of the plurality of matrices 130. The matrices 130 comprise a plurality of storage cells 165 that may, for example, take a form of a table 170. Each of a first column of cells 175 and a first row of cells 180 may have the randomized options stored therein. For example, the randomized options appearing in FIGS. 2A-2C have the following orderings:

| Matrix A | Matrix B | . . . | Matrix N |
|---|---|---|---|
| War | Food | . . . | Transportation |
| Food | War | . . . | Food |
| Transportation | Transportation | . . . | War |
| Water | Water | . . . | Water |

Matrix A, Matrix B, and Matrix N are illustrated in FIGS. 2A-2C, respectively.

The comparison module 140 runs a logical comparison of the first column of cells 175 with the first row of cells 180. Each of these logical comparisons are ultimately presented to the associated member 150 of the matrix 130 to make a pairwise selection. In particular, an option stored in one cell of the first column of cells 175 is not compared with that same option in the first row of cells 180, as it would not make logical sense. For example, FIG. 2A illustrates the table 170 of Matrix A, according to one embodiment. In this example, there is no pairwise comparison of War with War, Food with food, Transportation with Transportation, or Water with Water. Additionally, there is nei-ther a repeat of pairwise comparison within a same matrix 130. For example, in the FIG. 2A table 170 of Matrix A, the comparison module 145 will not compare the first cell (i.e., War) of the first row 180 with the second cell (i.e., Food) of the first column 175. This is because such a comparison is the same as a pairwise comparison between the second cell (i.e., Food) of the first row 180 and the first cell (i.e., War) of the first column 175.

According to an alternative embodiment, the matrix generator 105 creates a single ordered set of the options 135 which are stored in respective ones of the plurality of matrices 130. In other words, each of the first column of cells 175 and the first row of cells 180 in all matrices 130 may have the same order of options stored therein, rather than randomly ordered options stored therein. In such scenario, the random generator 125 is configured to present paired comparisons in a random order. For example, if the order of the options 135 across all matrices 130 is that of Matrix A (FIG. 2A), the random generator may present six paired comparisons to the member 150 in various combinations and permutations, such as:

| | First possible combination | Second possible | Third possible | Fourth possible |
|---|---|---|---|---|
| | order | combination order | combination order | combination order |
| 1. | Food or War? | War or Food? | Water or Transportation? | Food or Transportation? |
| 2. | Transportation or | War or Transportation? | Water or Food? | Transportation or |
| | War? | | | Water? |
| 3. | Water or War? | War or Water? | Transportation or | Food or Water? |
| | | | Food? | |
| 4. | Transportation or | Food or Transportation? | Water or War? | War or Transportation? |
| | Food? | | | |
| 5. | Water or Food? | Food or Water? | Transportation or | War or Food? |
| | | | War? | |
| 6. | Water or Transportation? | Transportation or | Food or War? | War or Water? |
| | | Water? | | |

It will be appreciated that randomly presenting the paired comparisons to the members 150 removes bias from the members' selections, as randomization eliminates indication of which options the host favors over others. In particular, the matrix generator 105 may build a list of all possible paired comparisons of the options 135, including various permutations of the paired comparisons. For example, the paired comparison of “Food or Water” (appearing in the first possible combination order column above) has an associated permutation of “Water or Food” (appearing in the second possible combination order column above). The random generator 125 may randomly select respective ones of the combinations of the options 135 when presenting paired comparisons to the member 150.

It will be noted that although the example tables 170 of each of the matrices 130 form a 4×4 matrix having sixteen storage cells 165, the comparison module 140 presents six pairwise comparisons to the associated member 150. In other words, six of the sixteen cells are stored with a selection stemming from a pairwise comparison presented to the member 150.

The user outputs 145 of FIGS. 2A-2C, are a result of the comparison module 145 counting the number of times one of the options 135 were selected by the member 150 in response to presentation of a pairwise comparison. For example, the User B Output 145 of FIG. 2B, illustrates the ‘Food’ option as having been selected once, each of the War′ and ‘Water’ options being selected twice, and the ‘Transportation’ option selected once. Because the comparison module 145 refrains from repeating the pairwise comparison within the Matrix B, the User B Output 14 is free from redundant counts.

The group prioritization output of FIG. 2D, illustrates the result of combining the plurality of user outputs 145 associated with respective ones of the matrices 130. As discussed above, the group prioritization module 155 calculates the single prioritized listing 158 of all the plurality of options 135 across all the members 150. For example, the group prioritization module 155 sums the pairwise selection count associated with each of the ‘Water’, ‘War’, ‘Food’, and ‘Transportation’ options according to the user outputs 145 of the comparison module 140. Summing the selected option count from the User A, User B, and User N outputs 145, the ‘Water’ option was prioritized as the greatest challenge to Adele village. To follow, the War′ and ‘Food’ options were the second greatest challenge, while ‘Transportation’ was the least of a challenge.

According to another embodiment, the comparison module 140 may comprise a weighting scheme. For example, in addition to the members 150 selecting respective ones of the paired options 135, the members 150 allocate a weight to the selected option 135. In other words, the allocated weight may quantify how much more the member 150 preferred the selected option over the non-selected option in the paired comparison. As such, the user outputs 145 may include both the number of times respective ones of the options 135 were selected by the member 150 in response to the pairwise comparison, and the weight associated with the selected option 135. The group prioritization module 155 may be configured to calculate the single prioritized listing 158 of all the plurality of options 135 across all the members 150 while leveraging the weights associated with the selected options 135. For example, the group prioritization module 155 sums the weights associated with respective ones of the selected pairwise options 135 to determine the group prioritized listing 158 of the options. In one embodiment, the weighting scheme may, for example, be a score between 1 (lowest preference)−5 (highest preference). However, it will be appreciated by those of ordinary skill in the art that any other weighting scheme may be used.

FIGS. 3-6 show various screenshot illustrations of the application stored on respective devices of the members 150, according to one embodiment.

The members 150 may access the system 100 via the application stored on their respective devices. For example, the devices used by the members 150 may include a smartphone, laptop, tablet, PC, or the like. The application provides a user interface that allows for presentation of paired comparisons, selection of the options 135, visual presentation of the group prioritized listing 158, and filtering capabilities. Reference will now be made to FIGS. 3-6.

As mentioned above, the comparison module 140 runs a pairwise comparison of the first column of cells 175 with the first row of cells 180 in each matrix 130. Each of these pairwise comparisons are ultimately presented to the associated member 150 of the matrix 130 to allow the member 150 to make a pairwise selection. The presentation of the pairwise comparison may, for example, occur as illustrated in FIG. 3. In the FIG. 3 screenshot example, the member 150 is being presented with a pairwise comparison of ‘Transportation’ with ‘Food.’ In one embodiment, the member 150 may simply touch a screen or click on a mouse to make a selection. Furthermore, during presentation of the various pairwise comparisons to the member 150, the member 150 may elect to view a real-time snapshot of the prioritized listing 158 of the plurality of options 135 across all the members 150. For example, the real-time snapshot of the prioritized listing 158 may be viewed by selecting ‘I just want to see the results’ from the user interface screen of the member's 150 device. In other words, prior to presentation of all the possible pairwise comparisons throughout all the plurality of matrices 130 to the respective members 150, the group prioritization module 155 maintains a real-time tally of the current member selections and thus a real-time prioritized listing 158 of the options as the members 150 are making their selections.

Additionally, as further mentioned above, the group prioritization module 155 calculates the single prioritized listing 158 of all the plurality of options 135 across all the members 150. The system 100 may, for example, present the single prioritized listing 158 across all the members 150 by way of a bar graph representation, as illustrated in FIG. 4. Of course, any other visual representation of the prioritized listing 158 is well within the scope of this disclosure.

The system 100 may be set up for anonymity such that a first member 150 cannot view the specific pairwise selection of options of a second member 150 during the selection process. Such anonymity is advantage in preventing bias toward specific op-tion(s) known to be selected by one of the members 150 deemed to be an influencer among the group of members 150.

As illustrated in FIGS. 5-6, the system 100 further allows for filtering out the plurality of option selections made by specific ones of the members 150. In particular, the member toggle 160 may be employed by the system 100 to allow for each member who views the group prioritization of options 158, to filter out the user output 145 results of one or more member users 150. In the FIG. 5 example illustration, the member 150 (e.g., Joe, Mary, or Wendy) may filter out the option selections (or ‘votes’) of one of the other members (e.g., Juan). In FIG. 5, the member 150 selects to filter out the results of Juan. As a result of that selection, the system 100 presents a modified or filtered view of the graphical representation of the prioritized listing 158 (See e.g., FIG. 6). Specifically, the filtered view of the graphical representation of the prioritized listing 158 does not include the option selections of Juan.

Having described some embodiments of the invention, additional embodiments will become apparent to those skilled in the art to which it pertains. Specifically, although reference was made throughout the specification and drawings to a group of members deciding on what the greatest challenge is to a village (e.g., Adele) and options (e.g., water, food, war, transportation), it will be appreciated that the system 100 and method embodiments are also relevant to any other group decision-making scenario. The embodiment of the greatest challenge to a village was described merely to readily convey various aspects of the paired comparison system and method as it pertains to efficient and accurate group decision making, but was not intended to limit the system in any way. For example, the paired comparison system may be advantageous to product managers (e.g., deciding on most important product features to design), wedding coordinators (e.g., wedding party deciding on floral arrangements), or social gatherings (e.g., group decision regarding where to go out), to name a few.

Various different weighting schemes are within the scope of the embodiments described above and are not limited to any specific weighting schemes found in the above examples. Additionally, the “options” described above are not limited to textual option descriptions (e.g., water, food, war, transportation, etc.) but may include visual or audio option descriptions (e.g., media file, image file, audio file).

The “host” referred to above may also participate in the pairwise selection of options, as the host may be included as a member of the group (e.g., group leader).

“Members” refer to users of the paired comparison system who interact with the system via an application on a computing device. The application provides a user interface which presents paired comparisons to the members, and allows the members to select respective ones of the options. As mentioned above, the host may also participate as a member of the system.

The terms “paired comparison” and “pairwise comparison” have been used interchangeably herein. The term “member” and “user” may be used interchangeably.

While the particular methods, devices and systems described herein and described in detail are fully capable of attaining the above-described objects and ad-vantages of the invention, it is to be understood that these are example embodiments of the invention and are thus representative of the subject matter which is broadly contem-plated by the present invention, that the scope of the present invention fully encom-passes other embodiments which may become obvious to those skilled in the art, and that the scope of the present invention is accordingly to be limited by nothing other than the appended claims, in which reference to an element in the singular means “one or more” and not “one and only one”, unless otherwise so recited in the claim.

It will be appreciated that modifications and variations of the invention are cov-ered by the above teachings and within the purview of the appended claims without de-parting from the spirit and intended scope of the invention.

1. A paired comparison system for a group of members, the system comprising:
a matrix generator to generate a plurality of matrices corresponding to respective ones of the members in the group, the matrix generator configured to receive a plurality of options and store the plurality of options within each of the plurality of matrices in a random order, each of the plurality of matrices having a first row of cells and a first column of cells, the randomized orders of the plurality of options being stored within the first row of cells and the first column of cells in each of the plurality of matrices;
a comparison module operable to present paired comparisons to respective ones of the members, wherein for empty cells of each of the plurality of matrices, the option stored in the associated row is compared with the option in the associated column and the member associated with the matrix selects one of the paired options; and
a group prioritization module to sum a number of times respective ones of the options were selected by the members in the group as one of the paired options and, in response, generate a single prioritized list of the plurality of options based on the number of times each one of the options was selected when presented in a paired comparison.

2. The system of claim 1, further comprising a host to create the plurality of options and transmit the plurality of options to the matrix generator.

3. The system of claim 2, wherein the plurality of options are choices to make when confronting at least one of a task, project, and problem.

4. The system of claim 2, wherein the comparison module presents the paired comparison of the option stored in the associated row with the option in the associated column for empty cells in each of the plurality of matrices so long as: (i) the option stored in the associated row is different than the option stored in the associated column, and (ii) the paired comparison is not a duplicate comparison to one previously presented to the member associated with the matrix.

5. The system of claim 4, wherein the comparison module further comprises a weighting scheme wherein in addition to the member associated with the matrix selecting one of the paired options, the member allocates a weight to the selected option.

6. The system of claim 5, wherein the weight is a number scheme ranging from 1 through 5.

7. The system of claim 5, wherein the group prioritization module further sums the allocated weight of respective ones of the selected options to create the single prioritized list of the plurality of options.

8. The system of claim 7, further comprising a plurality of mobile devices respectively associated with the members to present the paired comparison options to the members.

9. The system of claim 8, further comprising a member portal operable to receive login credentials from the members in the group, wherein for each of the received login credentials the matrix generator creates an associated one of the plurality of matrices.

10. The system of claim 9, further comprising a member toggle module communicatively coupled to the group prioritization module, the member toggle module operable to cause selection of one or more of the members in the group wherein the group prioritization module sums the number of times respective ones of the options were selected by those members selected by the member toggle module.

11. The system of claim 10, wherein the single prioritized list of the plurality of options is generated based on the number of times each one of the options was selected in the paired comparison by those members selected by the member toggle module.

12. The system of claim 11, wherein the single prioritized list of the plurality of options is updated in real-time based on the real-time selection of the members by the member toggle module

13. The system of claim 1, wherein the selections of each one of the paired options by a first member associated with a first one of the plurality of matrices is anonymous to a second member associated with a second one of the plurality of matrices.

14. A non-transitory computer readable medium storing instructions that when executed by a processor cause the processor to perform a method for paired comparison for a group of members comprising:
generating a plurality of matrices corresponding to respective ones of the members in the group, wherein a plurality of options stored within each of the plurality of matrices, each of the plurality of matrices having a first row of cells and a first column of cells, the plurality of options being stored within the first row of cells and the first column of cells in each of the plurality of matrices;
randomly presenting paired comparisons to respective ones of the members, wherein for selected empty cells of each of the plurality of matrices, the option stored in the associated row is compared with the option in the associated column and the member associated with the matrix selects one of the paired options; and
summing a number of times respective ones of the options are selected by the members in the group from the paired options and, in response, generating a single prioritized list of the plurality of options based on the number of times each one of the options was selected when presented in a paired comparison.

15. The non-transitory transitory computer readable medium of claim 14, wherein randomly presenting paired comparisons to respective ones of the members further comprises the members allocating a weight to the selected one of the paired options.

16. The non-transitory transitory computer readable medium of claim 15, wherein generating a single prioritized list of the plurality of options includes summing the weights associated with respective ones of the paired options.

17. The computer readable medium of claim 14, wherein summing a number of times respective ones of the options are selected by the members in the group from the paired options includes filtering out the plurality of option selections made by specific ones of the members.

18. The computer readable medium of claim 14, wherein generating a single prioritized list of the plurality of options includes maintaining a real-time tally of the current member selections and thus a real-time prioritized listing of the selected pairwise options while the members are making selections.

19. The computer readable medium of claim 14, wherein while randomly presenting paired comparisons, selections of respective ones of the paired options by a first member associated with a first one of the plurality of matrices is unknown to a second member associated with a second one of the plurality of matrices.

20. The computer readable medium of claim 14, wherein each of the plurality of options comprise at least one of an image, word, video, and audio.
